(19) United States
(12) Patent Application Publication
(10) Pub. No.: US 2007/0196776 A1
(43) Pub. Date: Aug. 23, 2007

(54) Stable High Ph Developer

(76) Inventors: Jianbing Huang, Trumbull, CT (US); Celin Savariar-Hauck, Badenhausen (DE); Manuel Klamt, Seesen-Bilderlahe (DE)

Correspondence Address: EASTMAN KODAK COMPANY;PATENT LEGAL STAFF, 343 STATE STREET, ROCHESTER, NY, 14650-2201, US

(21) Appl. No.: 10/591,727

(22) PCT Filed: Feb. 25, 2005
(86) PCT No.: PCT/EP05/02016

§ 371 Date: Sep. 5, 2006

(30) Foreign Application Priority Data
Mar. 12, 2004 (DE) 10 2004 012191.5

(51) Int. Cl. G03C 5/26

(52) U.S. Cl. 430/401

(57) ABSTRACT

Developer composition obtainable by (a) providing water, (b) dissolving such an amount of an alkaline component selected from alkali silicates, alkali hydroxides, Na₃PO₄, K₃PO₄, NR₄OH, wherein each R is independently selected from C₁C₄ alkyl groups and C₁-C₄ hydroxyalkyl groups, and mixtures thereof in the water provided in step (a) that a pH of more than 12 is obtained, and (c) dissolving a stabilizer selected from M₂CO₃, MHCO₃, or a mixture of 2 or more thereof, wherein each M is independently selected from Li, Na, K and NR′₄ and each R′ independently represents H or C₁-C₄ alkyl, in the solution obtained in step (b) wherein the amount of the added stabilizer is such that the amount of the added carbonate anion is 1.5 to 20 wt-%, based on the total weight of the developer composition.

The present invention relates to a high pH developer for photosensitive coatings. Furthermore, the invention relates to a process for producing such developers and a process for developing lithographic printing plate precursors.

The technical field of lithographic printing is based on the immiscibility of oil and water, wherein the oily material or the printing ink is preferably accepted by the image area, and the water or fountain solution is preferably accepted by the non-image area. When an appropriately produced surface is moistened with water and a printing ink is applied, the background or non-image area accepts the water and repels the printing ink, while the image area accepts the printing ink and repels the water. The printing ink in the image area is then transferred to the surface of a material such as paper, fabric and the like, on which the image is to be formed. Generally, however, the printing ink is first transferred to an intermediate material, referred to as blanket, which then in turn transfers the printing ink onto the surface of the material on which the image is to be formed; this technique is referred to as offset lithography.

A frequently used type of lithographic printing plate precursor (in this context the term “printing plate precursor” refers to a coated printing plate prior to exposure and developing) comprises a photosensitive coating applied onto a substrate on aluminum basis. The coating can react to radiation such that the exposed portion becomes so soluble that it is removed during the developing process. Such a plate is referred to as positive working. On the other hand, a plate is referred to as negative working if the exposed portion of the coating is hardened by the radiation. In both cases, the remaining image area accepts printing ink, i.e. is oleophilic, and the non-image area (background) accepts water, i.e. is hydrophilic. The differentiation between image and non-image areas takes place during exposure.

In conventional plates, a film containing the information to be transferred is attached to the plate precursor under vacuum in order to guarantee good contact. The plate is then exposed by means of a radiation source, part of which is comprised of UV radiation. When a positive plate is used, the area on the film corresponding to the image on the plate is so opaque that the light does not attack the plate, while the area on the film corresponding to the non-image area is clear and allows light to permeate the coating, whose solubility increases. In the case of a negative plate, the opposite takes place: The area on the film corresponding to the image on the plate is clear, while the non-image area is opaque. The coating beneath the clear film area is hardened due to the incident light, while the area not affected by the light is removed during developing. The light-hardened surface of a negative working plate is therefore oleophilic and accepts printing ink, while the non-image area that used to be coated with the coating removed by the developer is desensitized.

The more soluble areas of the coating (i.e. the background areas of the printing plate) are removed with an alkaline developer after exposure. Usually, aqueous high pH developers having a pH value of more than 12 are used to develop conventional positive working printing plates comprising phenolic resins, such as novolaks, in their coating. In newer positive or negative working thermoplates phenolic resins such as novolaks are frequently used in the coating as well, and high pH developers with a pH value above 12 are used for developing them.

High pH aqueous developers comprising alkali silicate are for example described in U.S. Pat. No. 4,606,995 A1, U.S. Pat. No. 4,500,625 A and U.S. Pat. No. 4,945,030 A, as well as in EP 0 732 628 A1, U.S. Pat. No. 4,259,434 A, U.S. Pat. No. 5,851,735 B, U.S. Pat. No. 4,469,776 A, EP 0 836 120 A and U.S. Pat. No. 4,452,880 A. Compared to high pH developers with alkali hydroxide as alkaline component, developers containing alkali silicate have the advantage that their etching effect on aluminum surfaces is lower; they are therefore often used for developing lithographic printing plates. The developer efficiency can be controlled by varying the SiO₂/M₂O ratio of the alkali silicates.

U.S. Pat. No. 4,711,836 describes an aqueous developer solution containing a quaternary ammonium hydroxide as alkaline component.

Due to the absorption of CO₂ from the ambient air, such high pH developers are relatively unstable; in common developing units, e.g. an immersion-type developing unit, a decrease in the developing efficiency is observed due to the decrease of the pH caused by the CO₂.

It is the object of the present invention to provide a developer composition with a pH value >12 for radiation-sensitive coatings which maintains its developing efficiency for an extended period of time.

This object is achieved by a developer composition obtainable by
(a) providing water,
(b) dissolving such an amount of an alkaline component selected from alkali silicates, alkali hydroxides, Na₃PO₄, K₃PO₄, NR₄OH, wherein each R is independently selected from C₁-C₄ alkyl groups and C₁-C₄ hydroxyalkyl groups, and mixtures thereof in the water provided in step (a) that a pH of more than 12 is obtained, and
(c) dissolving a stabilizer selected from M₂CO₃, MHCO₃, or a mixture of 2 or more thereof, wherein each M is independently selected from Li, Na, K and NR₁₄ and each R′ independently represents H or C₁-C₄ alkyl, in the solution obtained in step (b), wherein the amount of added stabilizer is such that the amount of added carbonate anion is 1.5 to 20 wt-% based on the total weight of the developer composition.

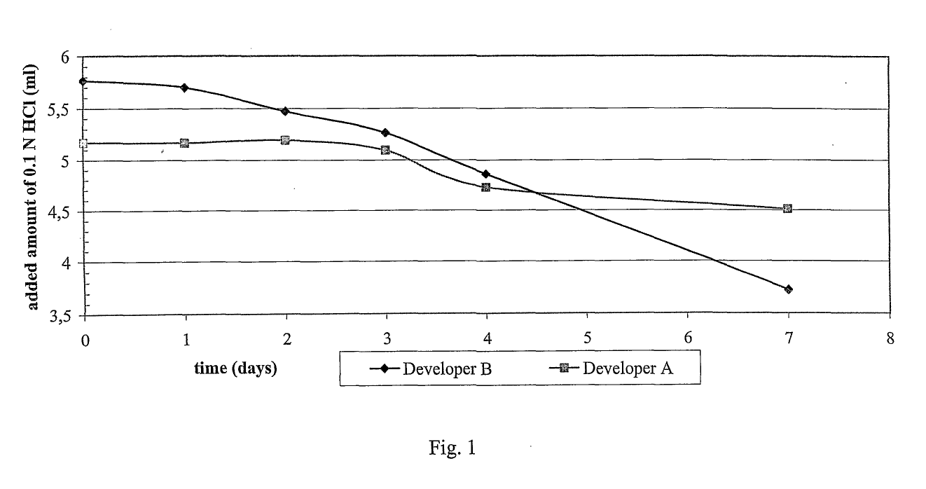

FIG. 1 is an illustration of the consumption of HCl during the potentiometric titration of Developers A and B in samples that were withdrawn from a beaker at different points in time, as described in Test 1 of Example 1.

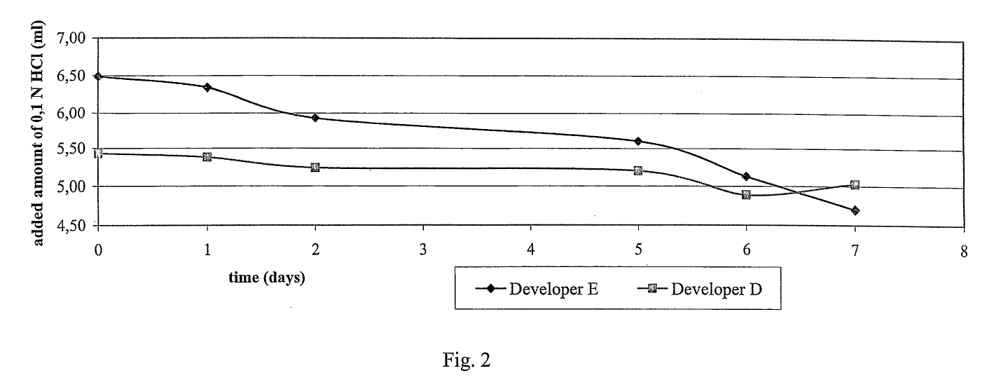

FIG. 2 is an illustration of the consumption of HCl during the potentiometric titration of Developers D and E in samples that were withdrawn from a beaker at different points in time, as described in Example 2.

The developer composition according of the present invention is an aqueous alkaline solution. Tap water, deionized water or distilled water can be used. The amount of water is preferably in the range of 45 to 95 wt.-%, based on the total weight of the developer, especially preferred 50 to 90 wt.-% and particularly preferred 55 to 85 wt.-%.

The alkaline component is selected from alkali silicates, alkali hydroxides, Na₃PO₄, K₃PO₄, NR₄OH, wherein each R is independently selected from C₁-C₄ alkyl groups and C₁-C₄ hydroxyalkyl groups, and mixtures of 2 or more thereof.

The amount of the alkaline component, or in case of mixtures the total amount of the alkaline components, is selected such that the pH value of the developer composition is more than 12, preferably, the pH is in the range of 12.5 to 14, especially preferred it is about 13.

As used in the present invention, the term “alkali silicates” also encompasses metasilicates and water glasses. Sodium silicates and potassium silicates are preferred silicates. When alkali silicates are used, the amount of silicate is preferably at least 1 wt.-% (calculated as SiO₂), based on the developer composition.

Of the alkali hydroxides, NaOH and KOH are especially preferred.

Usually the use of alkali metasilicates readily provides a pH value of more than 12 without further alkaline additives such as e.g. alkali hydroxide. When water glass is used, an alkali hydroxide is frequently used in addition in order to obtain a pH value of more than 12.

Preferred quaternary ammonium hydroxides NROH include for example tetramethyl ammonium hydroxide, trimethylethanol ammonium hydroxide, methyltriethanol ammonium hydroxide and mixtures thereof, an especially preferred ammonium hydroxide is tetramethyl ammonium hydroxide.

The stabilizer used in the present invention is selected from M₂CO₃ and MHCO₃ (M=Li, Na, K or NR′₄ wherein R′=H or C₁-C₄ alkyl) or mixtures thereof. Sodium salts are preferably used, and especially preferred is Na₂CO₃. The corresponding bicarbonate MHCO₃ can be used since it releases the carbonate anion upon dissolving in the aqueous high pH developer solution. It goes without saying that the stabilizer is present in dissociated form in the developer of the present invention; due to the high pH of the developer there might be changes with respect to the ammonium cation of ammonium carbonates (NR′₄)₂CO₃ or bicarbonates (NR′₄)HCO₃ in the solution.

The added amount of stabilizer is such that the amount of added carbonate anion is at least 1.5 wt-% and not more than 20 wt-%, based on the weight of the total composition; preferably the amount of added carbonate anion is at least 2.0 wt-%, more preferably at least 2.5 wt-% and especially preferably at least 4 wt-% and preferably at most 15 wt-%, more preferably at most 12 wt-% and especially preferably at most 9 wt-%. Due to the high pH value of the developer of the present invention, it is assumed that the bicarbonate anion is quantitatively converted into the carbonate anion (i.e. 1 mol added MHCO₃ releases 1 mol CO₃²⁻); therefore, it is possible to calculate the amount of MHCO₃ to be added for a desired amount of CO₃²⁻.

The developer can optionally comprise surfactants which can be amphoteric, non-ionic, cationic or anionic.

Examples of amphoteric surfactants are betaine derivatives, such as alkylamidopropyl betaine, alkyldimethyl betaine, bishydroxyethyl betaine, lauryl betaine; glycine derivatives, such as cocoamphocarboxy glycinate, lauroamphocarboxy glycinate, caprylamphocarboxy glycinate, oleoamphocarboxy glycinate, N-alkyl glycinate; imino derivatives, such as cocoimino propionate and octylimino propionate; imidazoline derivatives; lecithin derivatives and aminocarboxylic acids.

Examples of non-ionic surfactants are polyoxyethylene alkylethers, polyoxyethylene alkylphenylethers, polyoxyethylene polystyrylphenylethers, polyoxyethylene polyoxypropylene alkylethers, glycerin fatty acid partial esters, sorbitan fatty acid partial esters, pentaerythritol fatty acid partial esters, propylene glycol fatty acid mono esters, sucrose fatty acid partial esters, polyoxyethylene sorbitan fatty acid partial esters, polyoxyethylene sorbite fatty acid partial esters, polyethyleneglycol fatty acid esters, polyglycerin fatty acid partial esters, polyoxyethylene-modified castor oils, polyoxyethylene glycerin fatty acid partial esters, fatty acid diethanol amides, N,N-bis-2-hydroxyalkylamines, polyoxyethylene alkylamines, triethanolamine fatty acid esters and triallylaminoxides.

Examples of anionic surfactants are fatty acid salts, abietic acid salts, hydroxyalkanesulfonic acid salts, alkanesulfonic acid salts, salts of dialkylsulfosuccinic acid esters, linear allyl benzolsulfonic acid salts, branched alkyl benzolsulfonic acid salts, alkylnaphlthalene sulfonic acid salts, alkylphenoxypolyoxyethylenepropylsulfonic acid salts, polyoxyethylene alkylsulfophenylether salts, the sodium salt of N-methyl-N-oleyltaurine, the disodium salts of N-alkylsulfosuccinic acid monoamides, petroleum sulfonic acid salts, sulfated tallow oil, sulfuric acid ester salts of fatty acid alkyl esters, alkylsulfuric acid ester salts, polyoxyethylene alkylethersulfuric acid ester salts, fatty acid monoglyceride sulfuric acid ester salts, polyoxyethylene alkylphenylether sulfuric acid ester salts, polyoxyethylene styrylphenylether sulfuric acid ester salts, alkylphosphoric acid ester salts, polyoxyethylene alkyletherphosphoric acid ester salts, polyoxyethylene alkylphenyletherphosphoric acid ester salts, partially saponified products of styrene/maleic acid anhydride copolymers, partially saponified products of olefin/maleic acid hydride copolymers and condensates of naphthalenesulfonic acid salts/formaldehyde.

Examples of cationic surfactants are alkylamine salts, quaternary ammonium salts, polyoxyethylene alkylamine salts and polyethylene polyamine derivatives; amphoteric surfactants such as carboxy betaines, aminocarboxylic acids, sulfobetaines, amino sulfuric acid esters and imidazolines.

The “polyoxyethylene” moiety of the above-mentioned surfactants can be replaced with polyoxyalkylene groups, e.g. polyoxymethylene, polyoxypropylene and polyoxybutylene, and these surfactants can also be used in the developer according to the present invention.

Examples of further surfactants are those having perfluoroalkyl groups in their molecules. Specific examples include those of the anionic type, such as perfluoroalkylcarboxylic acid salts, perfluoroalkylsulfonic acid salts and perfluoroalkylphosphoric acid esters; those of the amphoteric type, such as perfluoroalkyl betaines; those of the cationic type, such as perfluoroalkyltrimethyl ammonium salts; and those of the non-ionic type, such as perfluoroalkylaminoxides, perfluoroalkylethylene oxide adducts, oligomers carrying perfluoroalkyl groups and hydrophilic groups, oligomers carrying perfluoroalkyl groups and lipophilic groups, oligomers carrying perfluoroalkyl groups, hydrophilic groups and lipophilic groups, and urethanes carrying perfluoroalkyl groups and lipophilic groups.

The above-mentioned surfactants can be used individually or in admixture, and they are preferably used in the developer in an amount of 0 to 10 wt.-%, particularly preferred 0.001 to 5 wt.-%, based on the weight of the developer composition.

The developer according to the present invention can optionally also comprise organic solvents. They are preferably selected from such solvents whose solubility in water is no more than about 10 wt.-%, preferably no more than 5 wt.-%. Examples of suitable organic solvents include 1-phenylethanol, 2-phenylethanol, 3-phenyl-1-propanol, 4-phenyl-1-butanol, 4-phenyl-2-butanol, 2-phenyl-1-butanol, 2-phenoxyethanol, 2-benzyloxyethanol, o-methoxybenzyl alcohol, m-methoxybenzyl alcohol, p-methoxybenzyl alcohol, benzyl alcohol, cyclohexanol, 2-methylcyclohexanol, 3-methylcyclohexanol, 4-methylcyclohexanol, N-phenyl-ethanolamine and N-phenyl-diethanolamine. The amount of organic solvent is preferably in the range of 0.1 to 5 wt.-%, based on the total weight of the developer composition. It goes without saying that the developer according to the present invention essentially does not contain any organic solvents which dissolve the printing coating areas that remain on the substrate.

The developer according to the present invention can optionally comprise one or more anti-foaming agents, such as e.g. polydimethyl siloxanes or copolymers thereof, polyethylene oxide/polypropylene oxide block copolymers, octyl alcohol and polyoxyethylene sorbitan monooleate. They are preferably present in an amount of 0 to 5 wt.-%, more preferred 0.01 to 1 wt.-%, based on the total weight of the developer composition.

Furthermore, the developer composition according to the present invention can optionally comprise one or more complexing agents which may for example be advantageous when hard water is used. Examples of suitable complexing agents include polyphosphoric acids and their sodium, potassium and ammonium salts; aminopolycarboxylic acids, such as ethylene diaminetetraacetic acid, diethylene triaminepentaacetic acid, triethylene tetraamine hexaacetic acid, hydroxyethylethylene diaminetriacetic acid, nitrilotriacetic acid, 1,2-diaminocyclohexanetetraacetic acid, 1,3-diamino-2-propanoltetraacetic acid etc. and their sodium, potassium and ammonium salts; aminotri(methylenephosphonic acid), ethylene diamine-tetra(methylenephosphonic acid), diethylene triaminepenta(methylenephosphonic acid), triethylene tetraaminhexa(methylenephosphonic acid), hydroxyethylethylene diamine-tri(methylenephosphonic acid) and 1-hydroxyethane-1,1-diphosphonic acid and its sodium, potassium and ammonium salts. Preferred complexing agents which at the same time function as etch inhibitors are phosphonic acid derivatives, such as those of the formula 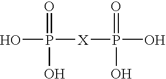
wherein X represents C₂-C₆ alkylene or 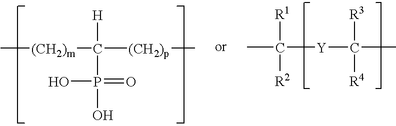
wherein
k=0 or 1;
m=1, 2, 3;
p=1, 2, 3;
r is an integer from 10 to 20;
R¹ and R² are independently H or C₁-C₄ alkyl;
R³ and R⁴ are independently H, OH or C₁-C₄ alkoxy; and
Y represents —R⁹N—(CH₂)ₙ—(NR⁸)_{q}—,
wherein
q=0 or 1,
n is an integer from 0 to 8 and
R⁸ and R⁹ are independently H, C₁-C₄ alkyl or —CH₂—P(O)(OH)₂.

Hydroxyethane diphosphonic acid, aminotri(methylene phosphonic acid), hexamethylene diaminotetra(methylene phosphonic acid), sodium salts thereof and mixtures are especially preferred.

The amount of complexing agent(s) is preferably 0 to 5 wt.-%, based on the total composition of the developer, especially preferred 0.02 to 0.5%.

The developer according to the present invention can optionally also comprise 0 to 1 wt.-%, preferably 0 to 0.2 wt.-%, of one or more common biocides (antimicrobial agents and/or fungicides). Examples of common biocides include e.g. the commercially available product Preventol CMK (active ingredient: 3-methyl-4-chloro-phenol) and the commercial product Mergal K15 (active ingredient combination of 1,2-benzisothiazoline-3-one and amino acid derivative).

The developer composition according to the present invention can also comprise further components such as glycerin and glycols, e.g. glycols of the formula 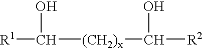
wherein R¹ and R² independently represent hydrogen or C₁-C₃ alkyl and x is 0, 1 or 2, with ethylene glycol being preferred. Glycols can for example be present in an amount from 0 to 20 wt.-% in the developer composition.

In order to improve the stability of alkaline developers with a pH of more than 12, it is merely necessary that more than 3 to 30 wt.-% of stabilizer be added to the alkaline developer, i.e. the stability of any commercial developer with a pH>12 can be improved by the addition of the stabilizer, independently of its composition.

The present invention also relates to concentrates of the inventive developer which are diluted with the necessary amount of water prior to their use.

Replenishers can also be stabilized according to the present invention.

The developers according to the present invention can be used for developing image-wise exposed radiation-sensitive coatings, preferably conventional UV-sensitive positive working coatings or IR-sensitive coatings, in particular those containing phenolic resins, e.g. novolak.

Developing is typically carried out at a temperature of 18 to 28° C., with the dwell time of the developer often being in the range of 5 to 60 seconds. Commercial processors can be used for developing.

The invention will be explained in more detail in the following examples; however, they shall not restrict the invention in any way.

### EXAMPLES

### Example 1

A developer solution was prepared by dissolving 100 g Na₂CO₃ in 900 g of the positive developer 9005® commercially available from Kodak Polychrome Graphics (positive developer containing potassium silicate, K₃PO₄ and ethylene glycol; pH 13; in the following referred to as “Developer B”). The resulting homogeneous solution will hereinafter be referred to as “Developer A”.

The stability of the alkaline developer to the uptake of CO₂ from the air was tested as follows.

Test 1 (Influence of the CO₂ Uptake on the Effective Alkalinity, Determined by Potentiometric Titration):

100 ml of the developer to be tested were put in a 250 ml beaker and stirred with a magnetic stirrer. After different time periods, 5 ml of the developer were withdrawn from the beaker and titrated with 0.1 N HCl using a potentiometric titrator. The amount of HCl corresponding to the first inflection point of the titration curve was used as a measure for the effective alkalinity. The results (ml HCl) for Developers A and B are listed in Table 1; the time given indicates the point of time when the sample was taken.

TABLE 1

| Time (days) | ml HCl Developer A | ml HCl Developer B |
|---|---|---|
| 0 | 5.173 | 5.767 |
| 1 | 5.170 | 5.699 |
| 2 | 5.194 | 5.472 |
| 3 | 5.097 | 5.265 |
| 4 | 4.729 | 4.861 |
| 7 | 4.511 | 3.723 |

The results are depicted as a graphic in FIG. 1.

As can be seen from Table 1 and FIG. 1, Developer A according to the present invention shows a clearly improved stability compared to Developer B.

Test 2 (Influence of the CO₂ Uptake on the pH Value):

100 ml of the developer to be tested were put in a 250 ml beaker and stirred with a magnetic stirrer. At different points of time, a standard pH electrode was immersed in the stirred developer and the pH value was read off. The results for Developers A and B are listed in Table 2; the time given indicates the point of time when the pH was measured.

TABLE 2

| Time (days) | pH of Developer A | pH of Developer B |
|---|---|---|
| 0 | 13.23 | 13.31 |
| 1 | 13.30 | 13.32 |
| 2 | 13.25 | 13.25 |
| 3 | 13.27 | 13.23 |
| 4 | 13.28 | 13.16 |
| 7 | 13.24 | 13.10 |

The slight difference in the initial pH values of the two developers is negligible for practical purposes.

It can be seen from Table 2 that the pH value of Developer A according to the present invention could be considered stable, with the exception of deviations within the margin of error, while a decrease in the pH value could be observed in Developer B.

Test 3 (Influence of the CO₂ Uptake on the Dissolution Rate of a Phenolic Coating):

100 ml of the developer to be tested were put in a 250 ml beaker and stirred with a magnetic stirrer. At different points in time, some developer was withdrawn from the beaker and dropped onto a non-irradiated DITP Gold® plate from Kodak Polychrome Graphics (Thermo CTP plate with preheating). After the developer drop had been rubbed off, the plate was blackened with a blackening ink (rub-on printing ink).

Table 3 below indicates the dwell times of the developer that were necessary in order to obtain, after rubbing off the developer, a point free of printing ink where the developer drop had been located. In other words, Table 3 shows the dwell times of the developer necessary to completely remove the radiation-sensitive coating of the plate.

TABLE 3

| Time when the | Dwell time (seconds) | Dwell time (seconds) |
|---|---|---|
| sample was taken | for Developer A | for Developer B |
| 0 | 20 | 25 |
| 1 | 20 | 45 |
| 3 | 20 | >60 |
| 4 | 30 | >60 |

It can be inferred from Table 3 that the strength of Developer A remained constant over 3 days and had even after 4 days not deteriorated considerably, compared with Developer B which showed a marked deterioration of the developing performance after only 1 day.

Test 4 (Influence of the CO₂ uptake on the Sensitivity of an Imagable Element):

A DITP Gold® plate from Kodak Polychrome Graphics was exposed through a gray scale with UV radiation (180 mJ/cm²) and the exposed plate was then heated in a continuous preheat oven at 132° C. and a conveying rate of 90 cm/min (dwell time in the oven was 80s). Then the plate was developed in a table processor; the developing time was 35s. Table 4 below shows the number of steps of the gray scale which could be visually observed on the printing plate after developing; the time given indicates the period of time that had passed since the developer was filled into the processor.

The more steps of the gray scale are visible, the weaker the developer. It can be inferred from Table 4 that the developer strength of Developer A only slightly changed within 4 days, while a strong decrease of developer strength could be observed for Developer B which after only 3 days led to impure backgrounds and thus useless prints.

TABLE 4

| | Gray scale steps with | Gray scale steps with |
|---|---|---|
| Time (days) | Developer A | Developer B |
| 0 | 11.5 | 13.5 |
| 1 | 10 | 13.5 |
| 2 | 11 | 16 |
| 3 | 11 | dirty background |
| 4 | 12 | dirty background |

### Example 2

A developer solution was prepared by dissolving 150 g Na₂CO₃ in 850 g MX-18130 (positive developer commercially available from Kodak Polychrome Graphics; containing potassium silicate, potassium hydroxide, K₃PO₄ and ethylene glycol; pH 13, referred to in the following as “Developer E”). The resulting homogeneous solution will hereinafter be referred to as “Developer D”.

Test 1 as described Example 1 was carried out; the results are summarized in Table 5 and FIG. 2.

TABLE 5

| Time (days) | ml HCl Developer D | ml HCl Developer E |
|---|---|---|
| 0 | 5.43 | 6.49 |
| 1 | 5.38 | 6.34 |
| 2 | 5.24 | 5.93 |
| 5 | 5.20 | 5.60 |
| 6 | 4.89 | 5.13 |
| 7 | 5.03 | 4.70 |

The results show that Developer D is more stable than Developer E.

1-15. (canceled)

16. A process for developing an exposed heat-sensitive printing plate precursor, comprising:
(a) producing an alkaline developer by
(i) dissolving such an amount of an alkali component selected from alkali silicates, alkali hydroxides, Na₃PO₄, and K₃PO₄ and mixtures thereof in water that a pH of more than 12 is obtained,
(ii) dissolving a stabilizer selected from M₂CO₃, MHCO₃, or a mixture of 2 or more thereof, wherein each M is independently selected from Li, Na, K and NR₁₄ and each R′ independently represents H or C₁-C₄ alkyl, in the solution obtained in step (i), wherein the amount of added stabilizer is such that the amount of the added carbonate anion is 1.5 to 20 wt %, based on the total weight of the developer composition, and
(iii) optionally dissolving at least one additive selected from glycols; amphoteric, non-ionic and cationic surfactants; anti-foaming agents; biocides; complexing agents and organic solvents either before or after the dissolution of the stabilizer in step (ii).
(b) contacting an exposed heat-sensitive printing plate precursor with the developer composition obtained in step (a), and
(c) rinsing with water.

17. Process according to claim 16, wherein the added stabilizer is Na₂CO₃.

18. Process according to claim 16 wherein the stabilizer is added in such an amount that the amount of the added carbonate anion is 2.5 to 12 wt %.

19. Process according to claim 16 wherein the alkaline component comprises an alkali silicate.

20. Process according to claim 16 wherein the pH value of the solution obtained in step (i) is in the range of from 13 to 14.

21. Process according to claim 16 wherein the radiation-sensitive coating of the printing plate precursor comprises a phenolic resin.

22. A process for developing an exposed heat-sensitive printing plate precursor, comprising
(a) contacting the exposed heat-sensitive printing plate precursor with an alkaline developer, and
(b) rinsing with water,
wherein the alkaline developer has been prepared by:
(i) dissolving such an amount of an alkali component selected from alkali silicates, alkali hydroxides, Na₃PO₄, and K₃PO₄ and mixtures thereof in water that a pH of more than 12 is obtained,
(ii) dissolving a stabilizer selected from M₂CO₃, MHCO₃, or a mixture of 2 or more thereof, wherein each M is independently selected from Li, Na, K and NR₁₄ and each R′ independently represents H or C₁-C₄ alkyl, in the solution obtained in step (i), wherein the amount of added stabilizer is such that the amount of the added carbonate anion is 1.5 to 20 wt %, based on the total weight of the developer composition, and
(iii) optionally dissolving at least one additive selected from glycols;
amphoteric, non-ionic and cationic surfactants; anti-foaming agents; biocides; complexing agents and organic solvents either before or after the dissolution of the stabilizer in step (ii).
